(19) United States
(12) Patent Application Publication
(10) Pub. No.: US 2024/0330252 A1
(43) Pub. Date: Oct. 3, 2024

(54) MIGRATING DATABASES FOR INSTANCES OF A WIRE-TRANSFER APPLICATION BETWEEN COMPUTING ENVIRONMENTS

(71) Applicant: Truist Bank, Charlotte, NC (US)

(72) Inventors: Murali Mohanan, Marietta, GA (US); Noel Ciminello, North Dartmouth, MA (US)

(73) Assignee: Truist Bank, Charlotte, NC (US)

(21) Appl. No.: 18/129,354

(22) Filed: Mar. 31, 2023

(51) Int. Cl. G06F 16/21; G06F 16/25; G06F 16/28

(52) U.S. Cl. CPC G06F 16/214; G06F 16/258; G06F 16/288

(57) ABSTRACT

A migration process for migrating data associated with a wire-transfer application from one computing environment to another computing environment can be performed. For example, a processor can receive a first set of tables stored in a first format from a first database associated with a first instance of a wire-transfer application executing in a first computing environment. The processor can identify differences between the first format and a second format of a second set of tables in a second database. The second database can be associated with a second instance of the wire-transfer application executing in a second computing environment. The processor can automatically convert the first set of tables from the first format to the second format based on the differences, and can automatically migrate the converted first set of tables into the second database for use by the second instance of the wire-transfer application.

### TECHNICAL FIELD

The present disclosure relates generally to computing environments and, more particularly (although not necessarily exclusively), to migrating databases for instances of a wire-transfer application between computing environments.

### BACKGROUND

Computer environments can perform interactions such as wire transfers between two or more computer systems. In the context of a wire transfer, the interaction between the computer systems may be facilitated by a wire-transfer application. Different computer environments can execute respective instances of the same wire-transfer application. Each instance may store data differently, for example because they are different versions of the same wire-transfer application or because they are configured differently from one another. For example, a first instance of the wire-transfer application may store data in a first database using a first format. And, a second instance of the wire-transfer application may store data in a second database using a second format that is different from the first format. The differing formats may make it challenging to migrate the data between the computer systems. For example, the data in the first database may be incompatible with the second instance of the wire-transfer application and/or the second database. Such incompatibilities can introduce a variety of problems if the data is migrated from the first database into the second database.

### BRIEF DESCRIPTION OF THE DRAWINGS

FIG. 1 is a block diagram of an example of two computing environments that execute respective instances of a wire-transfer application according to some aspects of the present disclosure.

FIG. 2 is a block diagram of an example of migration engine for converting a first set of tables according to some aspects of the present disclosure.

FIG. 3 is a block diagram of an example of a computing system for converting a set of tables for a wire-transfer application according to some aspects of the present disclosure.

FIG. 4 is a flowchart of a process for converting a set of tables for a wire-transfer application according to some examples of the present disclosure.

### DETAILED DESCRIPTION

A wire-transfer application, such as the Money Transfer System (MTS), can process wire transfer requests to perform wire transfers between computer systems. The same wire-transfer application (or even the same version of the same wire-transfer application) may be configured in different ways by different computing environments. For example, a first computing environment may configure the wire-transfer application to structure databases according to a particular format. A second computing environment may execute another instance of the wire-transfer application that structures its databases according to a different format. These different formats may cause problems when data from one database is migrated to another database. For example, an entity managing the second computing environment may acquire or merge with another entity managing the first computing environment. But, the format of the first database may be incompatible with the format of a second database for the instance of the wire-transfer application in the second computing environment. It may be desirable to migrate the data from the first database to the second database, but the second instance of the wire-transfer application may not be configured to read or use the migrated data, which can lead to numerous problems. Failing to adequately reformat the first set of tables may significantly impact the performance of the wire-transfer application. For example, the wire-transfer application may waste valuable computing resources (e.g., memory usage and processing power) attempting to access data that is not located in the correct table, or by accessing tables that are missing required fields. This may even prevent the wire-transfer application from performing wire transfers associated with converted data that originated from the first database.

Some examples of the present disclosure overcome one or more of the abovementioned problems by using a migration engine to convert tables, in a first database for a first instance of the wire-transfer application in a first computing environment, from a first format to a second format for tables in a second database for a second instance of the wire-transfer application in a second computing environment. The migration engine can identify differences in formatting, which can be used to convert the first set of tables in the first database into the second format. The migration engine may perform the complicated process of reformatting relationships between tables and their entries based on the difference in formats. Formatting methods that are similar between the first format and the second format can be maintained by the migration engine. The migration engine can address the differences in formatting by re-organizing and reformatting the first set of tables to align with the second format. This detailed reformatting of the first set of tables can prevent resource-intensive errors and increased latency for the second computing environment that would otherwise result from incorrectly formatted data.

Additionally, the migration engine may convert portions of the first set of tables over time. Some data from the first database may not be immediately available for conversion. The data that is available can be converted and automatically migrated. The converted and migrated data can then be used by the second instance of the wire-transfer application without having to wait for the rest of the data to be migrated. Because the first set of tables may be migrated piece by piece, intermediate testing can be performed to ensure that the migrated data has the second format and has successfully integrated into the second database. The migration engine can perform improved conversion for subsequent portions of the first set of tables based on the intermediate testing. For example, the migration engine may include a machine-learning model (e.g., a neural network) that is trained to convert sets of tables. The machine-learning model can receive the sets of tables as inputs and output a converted first set of tables that has the second format of the second set of tables. Automated testing may be performed on the converted first set of tables to identify conversion issues. The machine-learning model can be updated using a corrected version of the converted first set of tables. This can cause the machine-learning model to output converted tables without the conversion issues for subsequent table inputs. Migrating data piece by piece can also avoid the risk of converting the entire first set of tables incorrectly, which may be a more difficult and computationally expensive issue to address than incorrectly converting a small portion of the first set of tables.

In one particular example, a migration engine can receive data from a first instance of a wire-transfer application. The data may relate to wire transfers initiated for or received from the wire-transfer application. For example, the data may include identifiers of online accounts from which wire transfers can be performed, records of previous wire transfers performed from the online accounts, and amounts of previous wire transfers. The data may be organized according to a first format. For example, the data may be organized into a first set of tables. Each entry in the first set of tables may have certain parameters, classifications, reference numbers, interaction types, and more that tie the entries to other entries in the first set of tables. A second instance of the wire-transfer application may structure its data in a different format (e.g., a second format). For example, the data for the second instance may be organized into a second set of tables with different types of tables and relationships between entries. The second instance of the wire-transfer application may have difficulty with or may be entirely prevented from using data in the first set of tables because of the different formatting.

To successfully migrate the first set of tables to the second database, the migration engine can identify similarities and differences between the first format and the second format. The migration engine can maintain data structures that are formatted similarly. When the migration engine identifies a formatting difference, such as a type of table storing data, the migration engine can identify the data in the first set of tables needed to fulfill the second format. For example, if the second format involves formatting the data into an online account table listing online account identifiers, the migration engine can identify all of the online account identifier entries in the first set of data. The identified entries can be organized into an online account table.

In another example, the second format can involve classifying both credit and debit interactions for online accounts as a single interaction type. The migration engine may identify a difference with the first format, which involves classifying recurring credit interactions as a credit interaction type and recurring debit interactions as a debit interaction type. The migration engine may convert the data by consolidating the credit interaction type and the debit interaction type into a single interaction type. The single interaction type can be assigned to each online account that has performed credit or debit interactions. Once the differences are resolved by converting the data, the converted first set of tables can be automatically migrated to the second database. The second instance of the wire-transfer application can then use the converted data to perform wire transfers or other interactions.

These illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

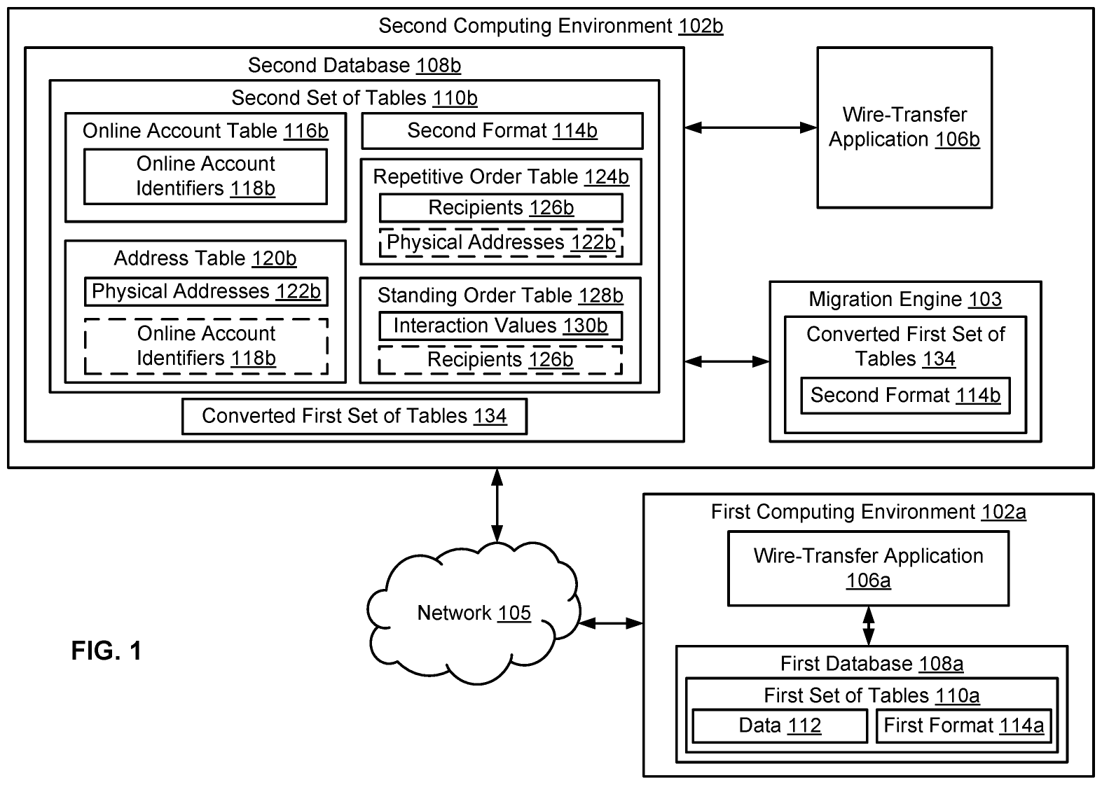

FIG. 1 is a block diagram of an example of two computing environments 102a-b that execute respective instances of a wire-transfer application 106 according to some aspects of the present disclosure. The first computing environment 102a and the second computing environment 102b communicate via one or more networks 105, such as a public data network, a private data network, or some combination thereof. A data network may include one or more of a variety of different types of networks, including a wireless network, a wired network, or a combination of a wired and wireless network. Examples of suitable networks 105 include the Internet, a personal area network, a local area network (LAN), a wide area network (WAN), or a wireless local area network (WLAN).

One example of the wire-transfer application 106 can include the Money Transfer System (MTS) application. The wire-transfer application 106 can receive, process, and perform requested wire transfers between computing devices. Multiple computing environments, such as the first computing environment 102a and the second computing environment 102b, can execute different instances of the wire-transfer application 106 to manage wire-transfer requests. Each instance can store data 112 related to wire transfers and online accounts in respective databases 108a-b, which may be internal or external to the instances. Because the computing environments 102a-b can be run by separate entities, formatting of the databases 108a-b can differ.

In some cases, such separate entities may merge into a single entity. For this reason or other reasons, it may be advantageous to combine the first database 108a and the second database 108b into a single database. But, a first set of tables 110a in the first database 108a may have a first format 114a that differs from a second format 114b of a second set of tables 110b in the second database 108b. For example, the second set of tables 110b may be organized into an online account table 116b, an address table 120b, a repetitive order table 124b, and a standing order table 128b. Many of the tables in the second set of tables 110b may be linked to entries in other tables, which can introduce complexity in conversion between formats 114a-b.

For example, the online account table 116b in the second set of tables 110b can store online account identifiers 118b used to interact with the second instance of the wire-transfer application 106b. This can include online account identifiers 118b that have previously transmitted or received wire transfers managed by the wire-transfer application 106b. The address table 120b can include physical addresses 122b for the online account identifiers 118. The physical addresses 122b can be the physical addresses of users associated with the online account identifiers 118. Each physical address 122b in the address table 120b can be linked to their corresponding online account identified in the online account table 116b. The repetitive order table 124b can include recipients 126b of recurring interactions performed by users with online account identifiers 118b. Interactions can include payments such as wire transfers that are performed via the wire-transfer application 106b. Recurring interactions may involve regularly occurring wire transfers such as mortgage or rent payments. The entries for the recipients 126b may include any recipient information required to complete an interaction such as a wire transfer. Each recipient 126b in the repetitive order table 124b can be linked to their corresponding physical address 122b in the address table 120b for the user initiating the interaction. The standing order table 128b can include interaction values 130b that can specify the value of recurring interactions. For example, a standing order for a rent payment may have an interaction value 130b that is equal to the rent value. Each interaction value 130b may be linked to their corresponding recipient 126b in the repetitive order table 124b for the recurring interaction.

Linking the second set of tables 110b in the second format 114b can allow the wire-transfer application 106b to quickly access related information without storing duplicate information. For example, the wire-transfer application 106b may access an interaction value 130b in the standing order table 128b to initiate a recurring interaction such as a student loan payment. The entry for the interaction value 130b may include a link to the corresponding recipient 126b of the student loan payment in the repetitive order table 124b. The entry for the recipient 126b may include a link to the physical address 122b in the address table 120b of the user paying the student loan. The entry for the physical address 122b may include a link to the online account identifier 118b in the online account table 116b for the user. Thus, the wire-transfer application 106b can follow the links to access the data required to perform the recurring interaction without having to search multiple tables in the set of tables 110b.

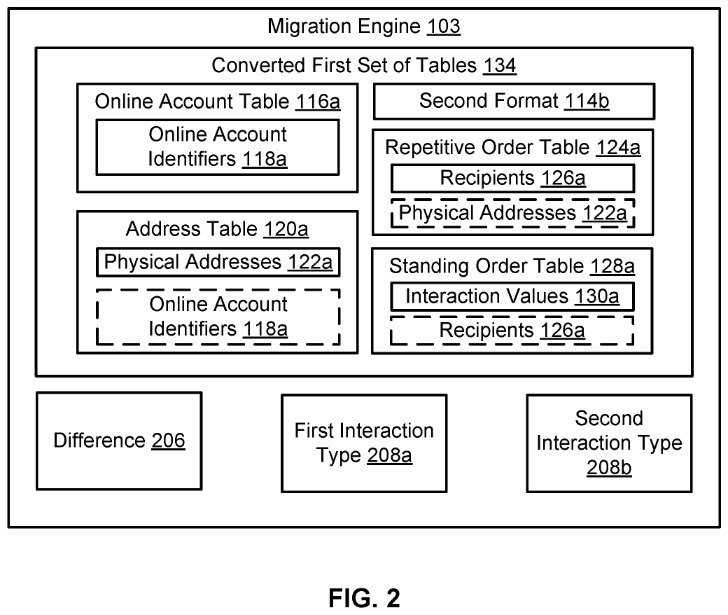

A migration engine 103 can be used to convert the first set of tables 110a from the first format 114a to the second format 114b. The converted first set of tables 134 can then be automatically migrated by the migration engine 103 from the first database 108a to the second database 108b. Because the converted first set of tables 134 may have the second format 114b, the converted first set of tables 134 may integrate into the second database 108b. An example of the migration engine 103 is further described with respect to FIG. 2.

FIG. 2 is a block diagram of an example of a migration engine 103 for converting the first set of tables 110a according to some aspects of the present disclosure. The migration engine 103 can receive the first set of tables 110a from the first database 108a. To convert the first set of tables 110a from the first format 114a to the second format 114b, the migration engine 103 can identify at least one difference 206 between the first format 114a and the second format 114b. For example, the migration engine 103 can determine that the second set of tables 110b is organized into an online account table 116b, an address table 120b, a repetitive order table 124b, and a standing order table 128b. The migration engine 103 may also determine that first set of tables 110a includes a single type of table that includes both online accounts and physical addresses, rather than separate online account tables and address tables.

In another example, the migration engine 103 can determine that the format of the entries in the first set of tables 110a differs from the second set of tables 110b. In some examples, the migration engine 103 can include a machine-learning model that can receive sets of tables 110a-b as inputs and can output a converted first set of tables 134 as an output. In other examples, the second format 114b may be a predefined set of rules that the migration engine 103 can apply to the first set of tables 110a. In still yet other examples, the migration engine 103 can compare table metadata for the sets of tables 110a-b. The metadata may indicate the rows and columns of the tables, and the migration engine 103 may identify differences in the metadata. For example, an address stored in the first set of tables 110a may store components of the address in a different order than an address stored in the address table 120b of the second set of tables 110b. Or, the migration engine 103 may determine that corresponding components in the first set of tables 110a (such as physical addresses corresponding to online accounts) are not linked. Instead, such data 112 in the first set of tables 110a may be redundantly included in multiple tables. Additionally, the sets of tables 110a-b may have different types of interactions that are recorded for the online accounts identified by the online account identifiers 118. One example of an interaction type 208 can be a general ledger number, which is an account number that can categorize types of recurring interactions. The interaction types 208 may categorize different recurring interactions for the different formats 114a-b.

After identifying the at least one difference 206, the migration engine 103 can automatically convert the first set of tables 110a to the second format 114b based on the difference 206. This can involve reorganizing (e.g., parsing) the content in first set of tables 110a into the table arrangement of the second format 114b. For example, the migration engine 103 may identify online account identifiers 118a in the first set of tables 110a and organize those online account identifiers 118a as entries in online account table 116a. Then, the migration engine 103 can identify physical addresses 122a that correspond to the online account identifiers 118a in the first set of tables 110a. The physical addresses 122a can be organized as entries in address table 120a. The migration engine 103 can then link entries of physical addresses 122a to their corresponding entries for online account identifiers 118a in the online account table 116a.

The migration engine 103 can similarly organize the first set of tables 110a into a repetitive order table 124a and a standing order table 128a. For example, the migration engine 103 can identify recipients 126a of recurring interactions performed by users that have online account identifiers 118a stored in the first set of tables 110a. The migration engine 103 can organize the recipients 126a into the repetitive order table 124a. And, the migration engine 103 can identify physical addresses 122a that correspond to the recipients 126a. The migration engine 103 can link the entries for the recipients 126a to the corresponding physical addresses 122a in the address table 120a. Further, the migration engine 103 can identify interaction values 130a for recurring interactions performed by users that have online account identifiers 118a. Such recurring interactions may have the same value for each interaction. The migration engine 103 can organize the interaction values 130a into a standing order table 128a. And, the migration engine 103 can identify recipients 126a of the recurring interactions that correspond with the interaction values 130a. The migration engine 103 can link the entries for the interaction values 130a to the corresponding recipients 126a in the repetitive order table 124a.

The migration engine 103 can also convert interaction types 208 for the first set of tables 110a. For example, the difference 206 may involve the first format 114a using a first interaction type 208a to categorize recurring interactions made with debit and savings online accounts. The second format 114b can involve using separate second interaction types 208b that include a debit interaction type for interactions made with a debit online account and a credit interaction type for interactions made with a credit online account. The migration engine 103 may convert the first interaction type 208a by identifying online account identifiers 118a that include the first interaction type 208a. The migration engine 103 can then identify interactions in the online account identifiers 118a that correspond to the second interaction types 208b. For example, the migration engine 103 may organize interactions stored for an online account, identified by an online account identifier 118a, into debit interactions and credit interactions. The migration engine 103 can then assign the second interaction types 208b to the debit interactions and credit interactions. That is, the debit interactions can be assigned the debit interaction type, and the credit interactions can be assigned the credit interaction type.

In some examples, the migration engine 103 may not receive the entire first set of tables 110a at once. Instead, portions of the first set of tables 110a may be received at different times. The migration engine 103 may iteratively perform conversions from the first format 114a to the second format 114b as portions of the first set of tables 110a are received from the first computing environment 102a. Subsequent conversions can be informed by previous conversions. For example, once the migration engine 103 has identified a difference 206 and determined a conversion to address the difference 206, later portions of the first set of tables 110a can be automatically converted without requiring the migration engine 103 to first identify that difference 206. Because the first set of tables 110a may be converted piece by piece into the converted first set of tables 134, the converted data in the second database 108b may be immediately used by the wire-transfer application 106b without having to wait for all of the data to be converted. Additionally, if the migration engine 103 improperly converts a first portion of the first set of tables 110a, the migration engine 103 can adjust conversions of subsequent portions to prevent repeating the error.

Although FIGS. 1-2 depicts a certain number and arrangement of components, this is for illustrative purposes and intended to be non-limiting. Other examples may include more components, fewer components, different components, or a different arrangement of the components shown in FIGS. 1-2.

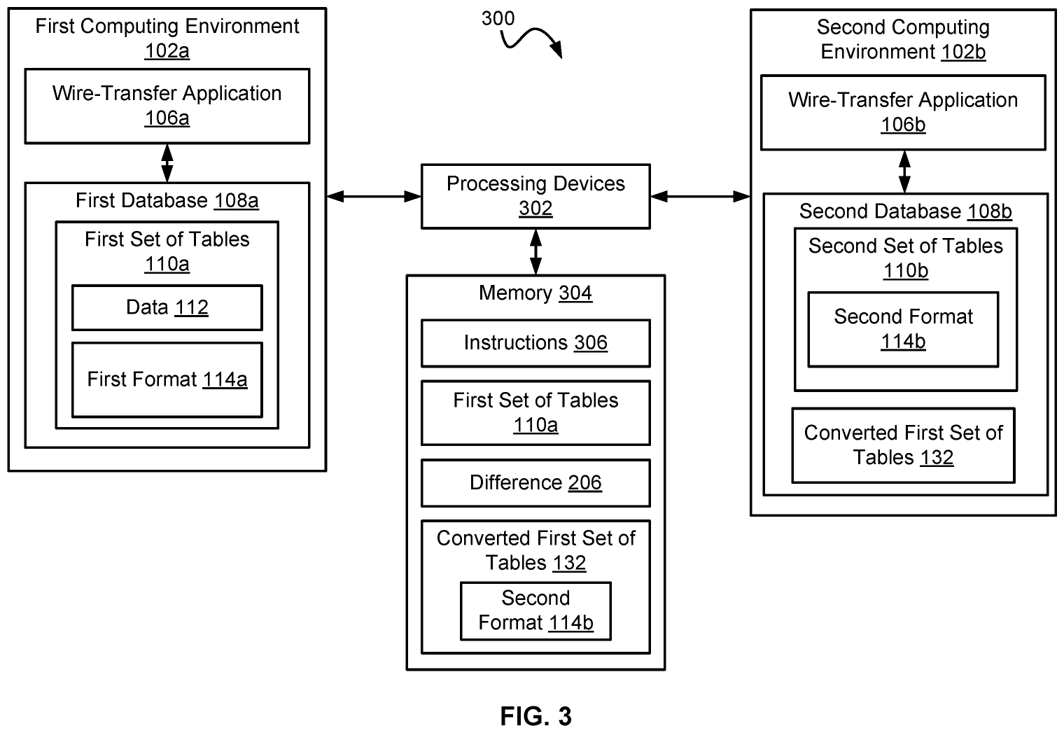

FIG. 3 is a block diagram of an example of a computing system 300 for converting a set of tables 110 for a wire-transfer application 106b according to some aspects of the present disclosure. The computing system 300 depicted in FIG. 3 includes a processing device 302 communicatively coupled to a memory 304.

The processing device 302 can include one processor or multiple processors. Non-limiting examples of the processing device 302 include a Field-Programmable Gate Array (FPGA), an application-specific integrated circuit (ASIC), a microprocessor, etc. The processing device 302 can execute instructions 306 stored in the memory 304 to perform operations. In some examples, the instructions 306 can include processor-specific instructions generated by a compiler or an interpreter from code written in any suitable computer-programming language, such as C, C++, C#, etc.

The memory 304 can include one memory or multiple memories. The memory 304 can be non-volatile and may include any type of memory that retains stored information when powered off. Non-limiting examples of the memory 304 include electrically erasable and programmable read-only memory (EEPROM), flash memory, or any other type of non-volatile memory. At least some of the memory can include a non-transitory computer-readable medium from which the processing device 302 can read instructions 306. A computer-readable medium can include electronic, optical, magnetic, or other storage devices capable of providing the processing device with computer-readable instructions or other program code. Examples of a computer-readable medium include magnetic disk(s), memory chip(s), ROM, RAM, an ASIC, a configured processor, optical storage, or any other non-transitory medium from which a computer processor can read the instructions 306.

In some examples, the processing device 302 can receive a first set of tables 110a from a first database 108a associated with a first instance of a wire-transfer application 106a executing in a first computing environment 102a. The first set of tables 110a can store data 112 in a first format 114a. The processing device 302 can identify at least on difference 206 between the first format 114a and a second format 114b of a second set of tables 110b in a second database 108b. The second database 108b can be associated with a second instance of the wire-transfer application 106b executing in a second computing environment 102b that is different from the first computing environment 102a. Based on identifying the at least one difference 206, the processing device 302 can automatically convert the first set of tables 110a from the first format 114a to the second format 114b. The processing device 302 can then automatically migrate the converted first set of tables 134 into the second database 108b for use by the wire-transfer application 106b.

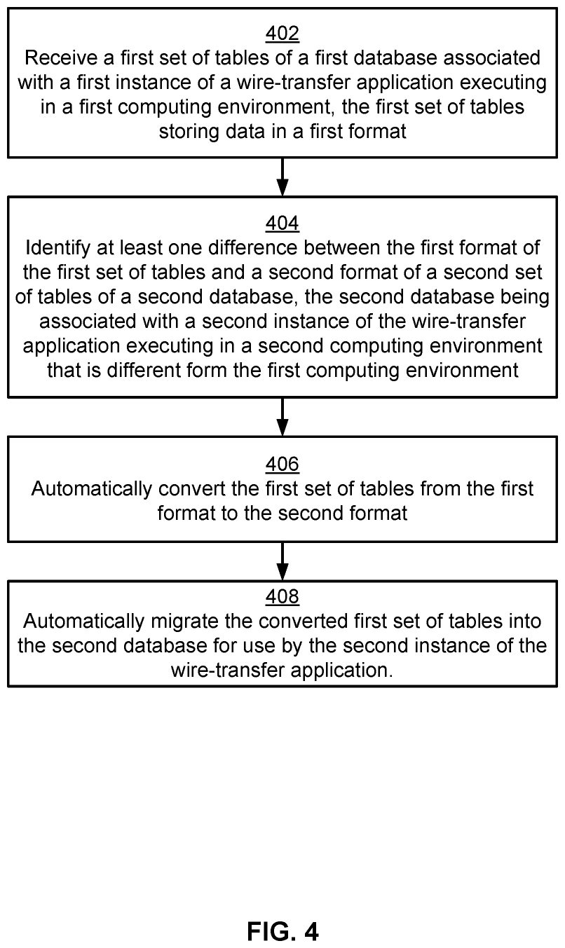

FIG. 4 is a flowchart of a process for migrating a set of tables 110 for a wire-transfer application 106b according to some examples of the present disclosure. FIG. 4 is described with references to components in FIGS. 1-3. Other examples can include more steps, fewer steps, different steps, or a different order of the steps than is depicted in FIG. 4.

At block 402, the processing device 302 can receive a first set of tables 110a from a first database 108a associated with a first instance of a wire-transfer application 106a executing in a first computing environment 102a. The first set of tables 110a can store data 112 in a first format 114a. For example, the first set of tables 110a can include a standing order table 128a that include interaction values 130a for recurring interactions, recipients 126a of recurring interactions, online account identifiers 118a for online accounts making the recurring interactions, and physical addresses 122a for users of the online accounts.

At block 404, the processing device 302 can identify at least one difference 206 between the first format 114a and a second format 114b of a second set of tables 110b in a second database 108b. The second database 108b can be associated with a second instance of the wire-transfer application 106b executing in a second computing environment 102b that is different from the first computing environment 102a. For example, the second set of tables 110b may also include standing order tables 128b, but the entries in the standing order tables 128b may be different in terms of content or format than the entries in the standing order table 128a in the first set of tables 110a. For instance, the standing order table 128b in the second set of tables 110b may only directly store the interaction values 130b. And instead of also storing the physical addresses 122b associated with the interaction values 130b in the standing order table 128b, the interaction values 130b can be linked to the corresponding physical addresses 122b in the address table 120b. The physical addresses 122b can, in turn, be linked to corresponding online account identifiers 118b for corresponding online accounts in the online account table 116b.

At block 406, based on identifying the at least one difference 206, the processing device 302 can automatically convert the first set of tables 110a from the first format 114a to the second format 114b. For example, the processing device 302 can remove the recipients 126a, physical addresses 122a, and online account identifiers 118a from the standing order table 128a in the first set of tables 110a. The processing device 302 can then link the recipients 126a that correspond to the interaction values 130a in the standing order table 128a to the interaction values 130a, rather than redundantly storing the recipients 126a in the standing order table 128a. For example, the processing device 302 can link the interaction values 130a to recipients 126a stored in a repetitive order table 124a. If the recipients 126a are not stored in repetitive order table 124a, the processing device 302 can organize the recipients 126a into the repetitive order table 124a. Converting the first set of tables 110a to the second format 114b can produce a converted first set of tables 134.

At block 408, the processing device 302 can automatically migrate the converted first set of tables 134 into the second database 108b for use by the wire-transfer application 106b. The converted first set of tables 134 can integrate into the second database 108b due to having the same second format 114b. The wire-transfer application 106b may then access the converted first set of tables 134 to perform operations, such as interactions between online accounts identified by online account identifiers 118.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a non-transitory computer-readable memory comprising instructions that are executable by the processing device for causing the processing device to:
receive a first set of tables of a first database associated with a first instance of a wire-transfer application executing in a first computing environment, the first set of tables storing data in a first format;
identify at least one difference between the first format of the first set of tables and a second format of a second set of tables in a second database, the second database being associated with a second instance of the wire-transfer application executing in a second computing environment that is different from the first computing environment;
based on identifying the at least one difference, automatically convert the first set of tables from the first format to the second format; and
automatically migrate the converted first set of tables into the second database for use by the second instance of the wire-transfer application.

2. The system of claim 1, wherein the instructions are further executable by the processing device for causing the processing device to automatically convert the first set of tables from the first format to the second format by:
parsing the first set of tables into an online account table and an address table, wherein the online account table stores online account identifiers, and wherein the address table stores physical addresses; and
linking the physical addresses in the address table to corresponding online account identifiers in the online account table.

3. The system of claim 2, wherein the second format involves the second set of tables being organized into a repetitive order table storing recipients of recurring interactions from online accounts identified in the online account table, wherein the recipients in the repetitive order table are linked to the corresponding physical addresses stored in the address table.

4. The system of claim 3, wherein the instructions are further executable by the processing device for causing the processing device to automatically convert the first set of tables from the first format to the second format by:
identifying a set of recipients of recurring interactions in the first set of tables;
identifying a set of physical addresses corresponding with the set of recipients of recurring interactions in the first set of tables;
organizing the set of recipients into a repetitive order table; and
linking the set of recipients to the set of physical addresses in the address table.

5. The system of claim 3, wherein the second format involves the second set of tables being organized into a standing order table storing interaction values for the recurring interactions from the online accounts identified in the online account table, wherein the interaction values in the standing order table are linked to corresponding recipients stored in the repetitive order table.

6. The system of claim 5, wherein the instructions are further executable by the processing device for causing the processing device to automatically convert the first set of tables from the first format to the second format by:
identifying a set of interaction values of recurring interactions in the first set of tables;
identifying another set of recipients of recurring interactions corresponding with the set of interaction values in the first set of tables;
organizing the set of interaction values into a standing order table; and
linking the set of interaction values to the corresponding other set of recipients in the repetitive order table.

7. The system of claim 3, wherein the second format involves the recurring interactions being associated with a set of interaction types, each interaction type in the set of interaction types representing a type of interaction performed by users of the online accounts identified in the online account table, wherein the first set of tables comprises another set of interaction types for recurring interactions in the first set of tables, wherein the other set of interaction types represents different types of interactions performed by users than the set of interaction types in the second set of tables.

8. The system of claim 7, wherein the instructions are further executable by the processing device for causing the processing device to automatically convert the first set of tables to the second format by:
identifying a first interaction type for recurring interactions in the first set of tables that corresponds to a second interaction type in the set of interaction types in the second set of tables; and
assigning the second interaction type to recipients of recurring interactions associated with the first interaction type in the first set of tables.

9. A method comprising:
receiving, by a processing device, a first set of tables of a first database associated with a first instance of a wire-transfer application executing in a first computing environment, the first set of tables storing data in a first format;
identifying, by the processing device, at least one difference between the first format of the first set of tables and a second format of a second set of tables of a second database, the second database being associated with a second instance of the wire-transfer application executing in a second computing environment that is different from the first computing environment;
based on identifying the at least one difference, automatically converting, by the processing device, the first set of tables from the first format to the second format; and
automatically migrating, by the processing device, the converted first set of tables into the second database for use by the second instance of the wire-transfer application.

10. The method of claim 9, wherein automatically converting the first set of tables from the first format to the second format further comprises:
parsing the first set of tables into an online account table and an address table, wherein the online account table stores online account identifiers, and wherein the address table stores physical addresses; and
linking the physical addresses in the address table to corresponding online account identifiers in the online account table.

11. The method of claim 10, wherein the second format involves the second set of tables being organized into a repetitive order table storing recipients of recurring interactions from online accounts identified in the online account table, wherein the recipients in the repetitive order table are linked to the corresponding physical addresses stored in the address table.

12. The method of claim 11, wherein automatically converting the first set of tables from the first format to the second format further comprises:
identifying a set of recipients of recurring interactions in the first set of tables;
identifying a set of physical addresses corresponding with the set of recipients of recurring interactions in the first set of tables;
organizing the set of recipients into a repetitive order table; and
linking the set of recipients to the set of physical addresses in the address table.

13. The method of claim 11, wherein the second format involves the second set of tables being organized into standing order tables storing interaction values for the recurring interactions from the online accounts identified in the online account table, wherein the interaction values in the standing order table are linked to corresponding recipients stored in the repetitive order table.

14. The method of claim 13, wherein automatically converting the first set of tables from the first format to the second format further comprises:
identifying a set of interaction values of recurring interactions in the first set of tables;
identifying another set of recipients of recurring interactions corresponding with the set of interaction values in the first set of tables;
organizing the set of interaction values into a standing order table; and
linking the set of interaction values to the corresponding other set of recipients in the repetitive order table.

15. The method of claim 11, wherein the second format involves the recurring interactions being associated with a set of interaction types, each interaction type in the set of interaction types representing a type of interaction performed by users of the online accounts identified in the online account table, wherein the first set of tables comprises another set of interaction types for recurring interactions in the first set of tables, wherein the other set of interaction types represents different types of interactions performed by users than the set of interaction types in the second set of tables.

16. The method of claim 15, wherein automatically converting the first set of tables to the second format further comprises:
identifying a first interaction type for recurring interactions in the first set of tables that corresponds to a second interaction type in the set of interaction types in the second set of tables; and
assigning the second interaction type to recipients of recurring interactions associated with the first interaction type in the first set of tables.

17. A non-transitory computer-readable medium comprising program code that is executable by a processing device for causing the processing device to:
receive a first set of tables of a first database associated with a first instance of a wire-transfer application executing in a first computing environment, the first set of tables storing data in a first format;
identify at least one difference between the first format of the first set of tables and a second format of a second set of tables of a second database, the second database being associated with a second instance of the wire-transfer application executing in a second computing environment that is different from the first computing environment;
based on identifying the at least one difference, automatically convert the first set of tables from the first format to the second format; and
automatically migrate the converted first set of tables into the second database for use by the second instance of the wire-transfer application.

18. The non-transitory computer-readable medium of claim 17, wherein the program code is further executable by the processing device for causing the processing device to automatically convert the first set of tables from the first format to the second format by:
parsing the first set of tables into an online account table and an address table, wherein the online account table stores online account identifiers, and wherein the address table stores physical addresses; and
linking the physical addresses in the address table to corresponding online account identifiers in the online account table.

19. The non-transitory computer-readable medium of claim 18, wherein the second format involves the recurring interactions being associated with a set of interaction types, each interaction type in the set of interaction types representing a type of interaction performed by users of the online accounts identified in the online account table, wherein the first set of tables comprises another set of interaction types for recurring interactions in the first set of tables, wherein the other set of interaction types represents different types of interactions performed by users than the set of interaction types in the second set of tables.

20. The non-transitory computer-readable medium of claim 19, wherein the program code is further executable by the processing device for causing the processing device to automatically convert the first set of tables to the second format by:
identifying a first interaction type for recurring interactions in the first set of tables that corresponds to a second interaction type in the set of interaction types in the second set of tables; and
assigning the second interaction type to recipients of recurring interactions associated with the first interaction type in the first set of tables.
